(19) United States
(12) Patent Application Publication
(10) Pub. No.: US 2017/0110860 A1
(43) Pub. Date: Apr. 20, 2017

(54) CABLE STRIPPING DEVICE AND METHOD FOR STRIPPING INSULATION FROM CABLES

(71) Applicant: Sheridan Repton, Grantham (GB)

(72) Inventor: Sheridan Repton, Grantham (GB)

(21) Appl. No.: 15/279,690

(22) Filed: Sep. 29, 2016

Related U.S. Application Data
(60) Provisional application No. 62/241,625, filed on Oct. 14, 2015.

(51) Int. Cl. H02G 1/12

(52) U.S. Cl. CPC H02G 1/1217

(57) ABSTRACT

A highly advantageous cable stripper and associated method are disclosed which utilizes a cable guide to control the position of a cable while being stripped of insulation.

### RELATED APPLICATIONS

The present application claims priority from U.S. Provisional Application Ser. No. 62/241,625, filed on Oct. 14, 2015 which is incorporated herein by reference.

### BACKGROUND

The present invention is related to a unique cable stripping device for stripping insulation from cables. Electrical cables are used in devices and buildings throughout modern society. Some cables distribute electrical power from power sources to homes and other buildings, while other cables are used to distribute the power throughout the buildings to receptacles, lighting and other equipment. Electrical devices also use cables to distribute electrical signals and power to and within the devices. Depending on the application, electrical cables can be installed by electricians, electrical equipment installers, builders and others.

Cables include one or more metal conductor and some type of electrical insulation. The conductor is typically mostly either copper or aluminum which carries electrical current with low resistance. The insulators can be plastic, rubber, polymers or another material that is substantially electrically non-conductive to protect the conductor from damage and to protect against unwanted current flow from the conductor. As used herein, the term “cables” should be understood to include wires which have one or more strands of an electrical conductive material that has an insulating cover along at least part of the length.

Since there are so many uses for cables, they come in a variety of sizes, types, and configurations depending on the application. Smaller cables for carrying relatively smaller current can have a single, solid strand or multiple strands of conductors using a common insulated cover. Larger cables for carrying relatively larger current typically have multiple larger conductors that are wound together and that are surrounded longitudinally by a common insulator. Both small and large cables can have a substantially round cross section. Other cables can have a combination of two or more cables surrounded by a common insulator, jacket or sheath. One example of such is non-metallic sheathed cable (also commonly called Romex, NM cable) which can also include a bare ground conductor along with two or more individually insulated conductors. The outer covering of NM cable is included when referring generally to insulators herein. Depending on the configuration, NM cable can have flat surfaces, and can have a non-round and/or asymmetrical, overall cross section.

There is an increasing demand for recycling metals in society. Some areas require certain materials to be recycled. Among the most recycled materials are metals, including copper and aluminum. Scraps of these metals, including scrap cable, can be sold for recycling, and naturally recyclers pay much more for pure aluminum and copper scrap than they pay for cable that includes the insulator. Applicant recognizes that recycling of scrap cable is more likely to occur if the insulation can be removed in a quick, easy and convenient manner.

Cable strippers can be used for removing the insulation from cables prior to recycling. Cable strippers for this purpose can be used for removing long lengths of insulation from conductors. These cable strippers should not be confused with common wire strippers that are used for removing a short section of insulation at an end of a cable for electrical connection since these common wire strippers are generally not suitable for stripping long lengths of insulation.

Conventional cable strippers suffer from a variety of flaws that make them inconvenient, time consuming, and/or difficult to use. Some conventional cable strippers are large machines that utilize a motor or hand crank to force the cable through the machine or to rotate a cutting assembly. These machines are large, expensive and inconvenient, and typically require time to set them up for a specific cable type. Other conventional cable strippers rely on specialized cutting wheels or blades that are expensive and inconvenient to use since they can only be obtained from the original manufacturer of the cable stripper. Some conventional cable strippers have to be adjusted for the size of wire to be stripped or have a series of slots for different sized cables which makes them bulky, inconvenient to use and time consuming. Some use adjustable spring mechanisms to force the blade and the cable together. These must be adjusted carefully so that the blade cuts just deep enough to split the insulator of round cross section cables. Many or all of these conventional cable strippers are unable to strip cables with non-round cross sections.

Another concern with conventional cable strippers are exposed blades which can be dangerous for the user, especially if the cable stripper is picked up without looking, as is common with tools that are held in a tool belt. Many of these conventional cable strippers offer no protections from the cutter, or have open channels or other shapes into which fingers can easily contact the cutter when the device is picked up.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a method and associated apparatus are described for stripping cable insulation from cable conductors of an electrical cable. A cable stripper can include a body which can define a portion of a cable passage. The passage can extend from a first end of the body to a second end of the body and the body can be configured for receiving the electrical cable in the passage. The cable stripper can also include a blade holder connected to the body and configured for holding a blade such that the blade is extendable into the passage to cut conductor insulation by applying a force to the blade holder. The blade can be retracted from the passage when the force is not applied to the blade holder. A gripper mechanism can be connected to the body. The gripper mechanism can define a portion of the cable passage and the gripper mechanism can be configured such that applying a force to the gripper mechanism extends the gripper mechanism and narrows a portion of the passage to position the electrical conductor relatively closer to the blade. Passing the electrical cable through the passage while extending the blade and applying the force to the gripper mechanism can cut the cable insulation and allow the cable insulation to be peeled away from the cable conductor.

A method for stripping insulation from a cable using a cable stripper is disclosed. The method includes inserting an end of the cable into a proximal end of a passage of the cable stripper. The cable can be pushed through the passage until the cable end extends from a distal end of the passage. A force can be applied to a gripper mechanism to extend the gripper mechanism and thereby position the cable under a blade. Another force can be applied to a blade holder to extend a blade into the passage and into the insulation of the cable. The cable can be pulled through the passage to cut the cable insulation along the length of the cable.

In an embodiment, a cable stripper is disclosed for cutting insulation of an electrical cable. A body defines at least a portion of a passage, the passage extends from one end of the body to another end of the body and can be configured for passing electrical cables longitudinally through the passage. A blade holder is included for selectively extending a blade into the passage and retracting the blade from the passage. A gripper mechanism is included for selectively moving electrical cables in the passage relatively toward and away from the blade. A cable guide is included and is configured for guiding electrical cables laterally toward the blade while the electrical cables are moving longitudinally through the passage. The cable guide can include a tapered shape that has a relatively wider recess away from the blade and a relatively narrower recess closer to the blade.

In addition to the example aspects and embodiments described above, further aspects and embodiments will become apparent by reference to the drawings and by study of the following descriptions

### BRIEF DESCRIPTION OF THE DRAWINGS

FIG. 1 is an illustration of a cable stripper in accordance with the present disclosure for use in removing insulation from cables.

FIG. 2 is a side view of a user holding the cable stripper.

FIG. 3 is a perspective cut away view of the cable stripper showing a blade for cutting insulation and a gripper mechanism.

FIG. 4 is a perspective view of the gripper mechanism shown in FIG. 3.

FIG. 5 is a view showing one end of the cable stripper.

FIG. 6 is a cross section view of the cable stripper.

FIG. 7 is an end view of the cable stripper.

FIG. 8 is a view showing a proximal end of a passage through the cable stripper.

FIG. 9 is a cross section view of the cable stripper with a relatively large cable inserted through the passage.

FIG. 10 is an end view of an embodiment of a conically shaped passage through the cable stripper.

FIG. 11 is a side view of the conically shaped passage shown in FIG. 10.

FIG. 12 is a diagram of a method for stripping insulation from cables using the cable stripper.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the Figures, and is in no way intended as being limiting.

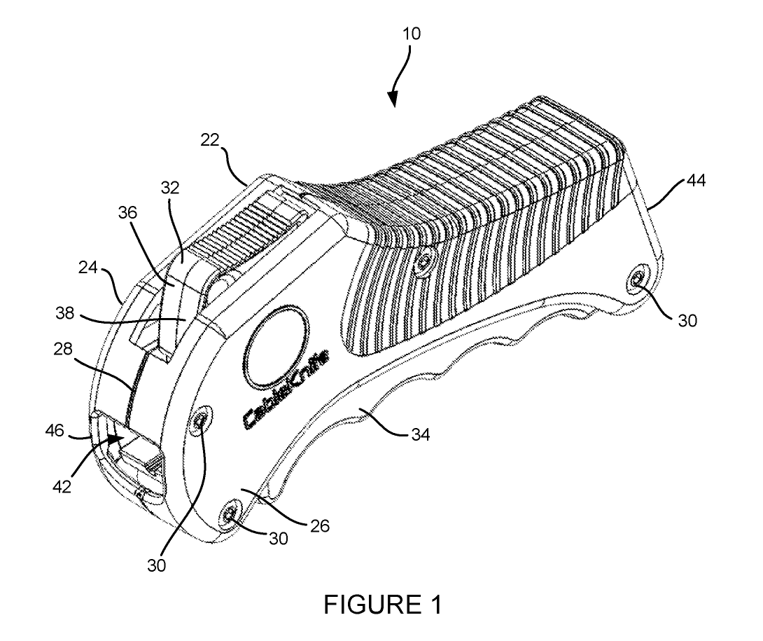

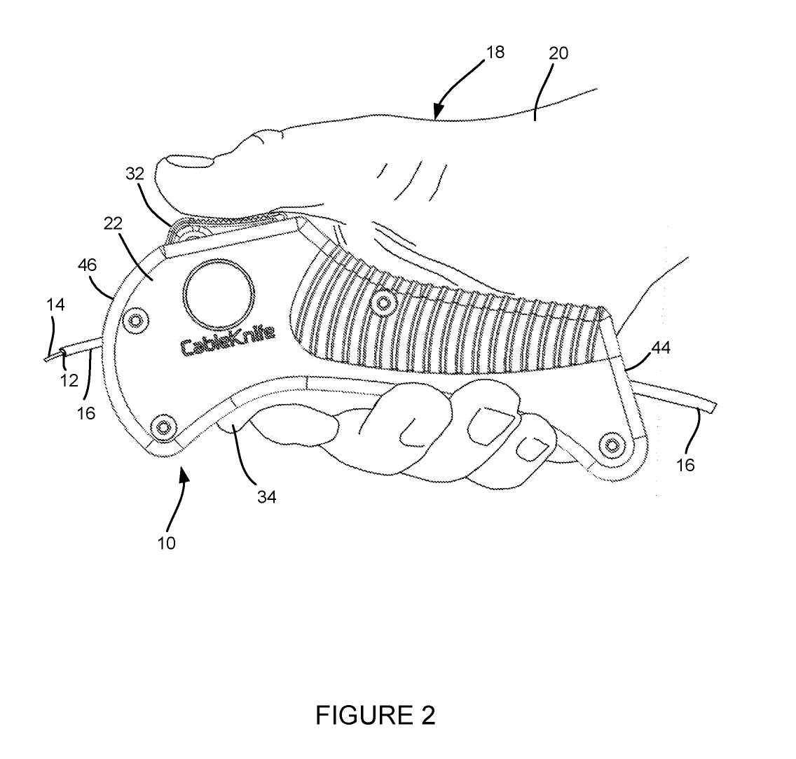

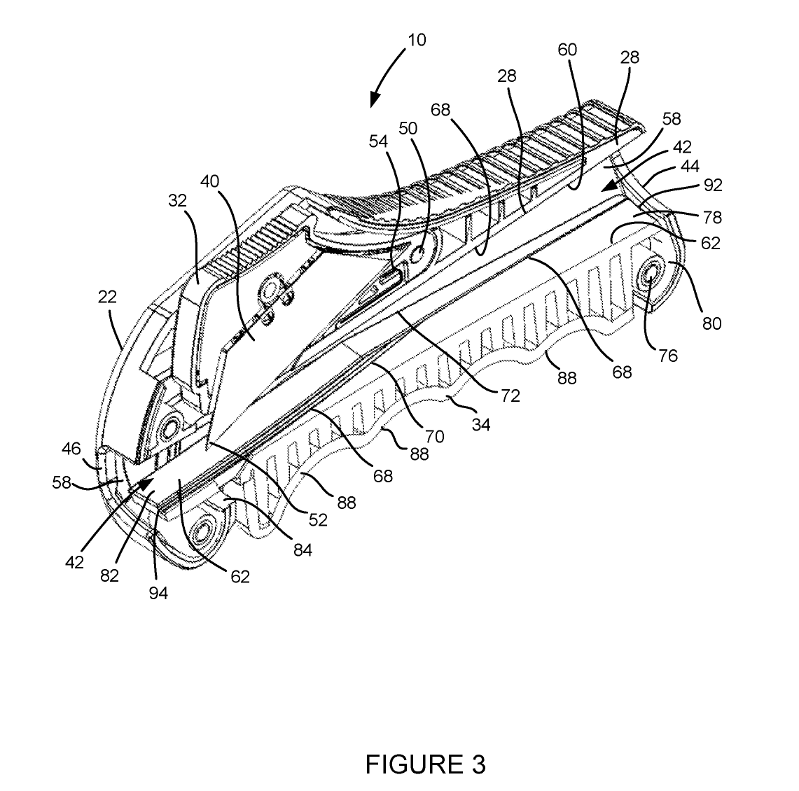

Attention is now directed to the Figures wherein like items may refer to like components throughout the various views. FIG. 1 is a diagrammatic representation of a unique cable stripper 10 which can be employed for stripping insulation 12 (see FIG. 2) from a conductor 14 of a cable 16 in a quick and convenient manner to facilitate recycling of the conductor material. Cable stripper 10, which can also be referred to as a cable knife, is configured for a user 18 to hold and control using a single hand 20. Cable stripper 10 (FIG. 1) includes a body 22 having a first side 24 and a second side 26, see FIG. 1. The first and second sides are formed to engage one another along a joint 28 and fasteners 30 can be used to secure the sides 24 and 26 together to form the body 22. Cable stripper 10 also includes a blade holder 32 and a gripper mechanism 34 which are connected to the body 22. The blade holder 32 includes a first blade holder side 36 and a second blade holder side 38 which cooperate to hold a blade 40 (FIG. 3). The body 22 and gripper mechanism 34 define a passage 42 which extends between a proximal end 44 and a distal end 46 through the cable stripper.

To use the cable stripper, FIG. 2, the cable 16 is inserted into the proximal end 44 of the cavity and pushed through the passage until the end of the cable extends out of the distal end 46 of the passage far enough that the cable can be grasped by the user's free hand. The user 18 then squeezes the gripper mechanism 34, using the palm and fingers, to center the cable in the passage. The user then presses the blade holder 32 with the user's thumb 48 to move the blade into the insulation of the cable. The user then pulls the cable through the cable stripper while holding the gripper mechanism and the blade holder and the insulation is cut. When the end of the cable is reached, the insulation can be easily peeled away from the conductor and discarded or sorted for recycling and the conductor is bare and is ready to be recycled. The cable stripper is shown in FIG. 2 in the user's right hand, in which case the user can pull the cable through the stripper with the left hand. However, the cable stripper is configured for use in either hand so the cable stripper can also be held in a user's left hand and the cable can be pulled through the device with the user's right hand.

Since the blade holder 32 and the gripper mechanism 34 are activated separately from one another, the user can adjust the amount of pressure exerted on either separately to optimize the cutting by separately feeling the cut and the grip of the cable. For example, if the cut is too deep and the blade is dragging on the conductor then the blade could be worn prematurely and the cable can be harder to pull than what is actually required to cut the insulation. Also, since the user can adjust the pressure exerted by the blade, the user has a feel for how the blade is positioned when cutting and it is therefore less likely for the cable to roll when stripping the cable. This is especially important when stripping relatively smaller cables since they have more of a tendency to roll when stripped than do relatively larger cables. The cable stripper 10 also allows the user to feel if the gripper mechanism is squeezing the cable too hard or not hard enough to position and/or slide the cable through the stripper.

The cable stripper is shown in FIG. 3 without the second side 26 of the body 22 and without the second side 38 of the blade holder. The cable stripper of FIG. 3 also only shows approximately half of the gripper mechanism 34, which has been divided longitudinally by a plane that is approximately co-planar with the joint 28 between the sides of the body. In this view, the blade 40 can be seen connected to the blade holder 32. When fully assembled, the blade 40 is held in the blade holder between the first side 36 and the second side 38. The blade holder is pivotally connected to the body 22 at a pivot 50. The blade holder can pivot from a retracted position in which the blade is located out of the passage 42, to any one of a range of extended positions in which a cutting edge 52 of the blade is extended into the passage 42 a range of depths. A bias spring 54 biases the blade holder into the retracted position and the blade holder can be moved into any of the extended positions by pushing with the user's thumb. FIG. 3 shows the blade extended into the passage. The blade holder can include a textured portion 56 for added grip between the user's thumb and the blade holder.

The blade 40 used with the cable stripper 10 is a common utility knife blade that has two mirror image pointed ends that allow the blade to be held by the blade holder with either end positioned for use. When one end becomes dull, the blade can be turned around so that the other end of the blade can be used. These utility knife blades can be found at most any hardware or home improvement store and are relatively inexpensive. This makes blade replacement an inexpensive and easy task.

The passage 42 extends through the body 22 (FIG. 3) from a proximal end 44 of the passage to a distal end 46 of the passage. The first and second sides of the body include passage side walls 58 that face one another across the passage. The body 22 also includes a passage upper surface 60 that defines the upper surface of the passage. The upper surface 60 is generally opposite of a passage lower surface 62 which is formed by the gripper mechanism. Together the side walls 58, passage upper surface 60 and passage lower surface 62 substantially define the passage through the cable stripper.

Cable stripper 10 includes a cable guide 68 which includes a lower guide portion 70 that can be formed in the surface 62 of the gripper mechanism, and an upper guide portion 72 that can be formed in the surface 60 of the body. The cable guide 68 can have a generally conical shape that tapers from the proximal end of the passage to the distal end of the passage. The upper guide portion can be formed by the first and second sides of the body and can be mirror imaged across the joint 28 between the sides with each side defining approximately one part of the cone shape. In an embodiment, the conical shape of the cable guide is not regular, it is symmetrical left to right (side to side) but not top to bottom. Described another way, the portion of the cone defined by the body is not symmetrical with the portion of the cone defined by the gripper mechanism. In another embodiment, the conical shape of the cable guide can be symmetrical top to bottom as well as side to side. The conical shaped cable guide includes an opening in the upper guide portion through which the blade is extendable.

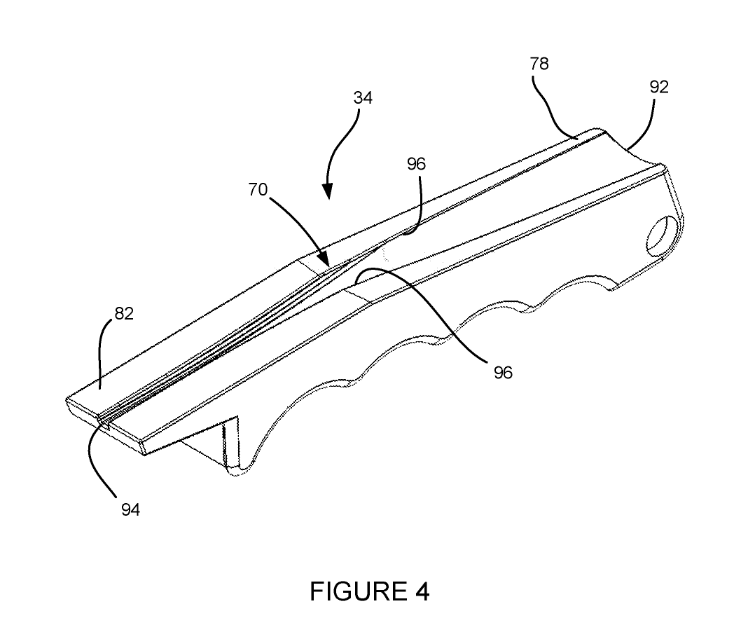

The gripper mechanism 34 is shown in FIG. 4 separate from the rest of the cable stripper for purposes of understanding the shape of the gripper mechanism. The gripper mechanism can include the lower portion 70 of the conical shaped cable guide. The cable guide can extend from the proximal end 78 of the gripper to the distal end 82 of the gripper. The conical shape of the guide can be partially defined such that the guide changes from a relatively wide recess profile at a proximal end 92 of the cable guide 68 to a relatively narrow recess at a distal end 94 of the cable guide. The relatively wide recess profile at the proximal end of the guide is shaped and dimensioned to engage and guide relatively larger cables to be centered under the blade; while the relatively narrow recess at the distal end 94 of the guide is shaped and dimensioned to engage and guide relatively smaller cables to be centered under the blade. The cable guide includes an intermediate profile 96 between the proximal and distal ends that is sized for engaging and guiding cables having dimensions between those which correspond to the profiles of the proximal and distal ends of the guide. The cone can start with a relatively larger generally circular profile, or cross section, at the proximal end 92, and can finish with a relatively smaller square shaped profile, or cross section, at the distal end 94 of the guide. In another embodiment, the cone can start with a relatively larger generally circular profile at the proximal end and can finish with a relatively smaller circular profile at the distal end. Other conical type arrangements may also be useful. At least part of the gripper upper surface can be configured to keep the cable in the center of the cutting cone for a range of different cable diameters and configurations.

Gripper mechanism 34, FIG. 3, is pivotally mounted to the cable stripper body 22 using a pivot 76 located toward a proximal end 78 of the gripper. The gripper mechanism can pivot from a retracted position to a range of extended positions. In the retracted position, a bias spring 80 holds a distal end 82 of the gripper mechanism away from the blade and against a gripper mechanism stop 84 which limits the rotational movement of the gripper mechanism in one rotational direction. The extended positions include a range of positions in which the gripper mechanism can be rotated about the pivot 60. The extended positions make the distal end of the passage 42 relatively smaller than when in the gripper is in the retracted position. Also, given any single position of the blade holder and blade, the rotation of the gripper mechanism from the retracted position to the extended position moves the distal end 82 of the gripper mechanism closer to the blade.

The gripper mechanism can include grip recesses 88 which engage a user's fingers when the cable stripper is used to help prevent the user's hand from slipping. The body 22 of the cable stripper can include a series of ridges 90 which can engage the user's palm to help prevent the user's hand from slipping.

The gripper mechanism can be made from a plastic, polymer, metal and/or other material. The gripper mechanism can be made from a material or can have a coating that has a reduced frictional resistance to the sliding motion of cable insulation to allow the cable to be guided through the cable stripper with less resistance than when other materials are used for the gripper 34.

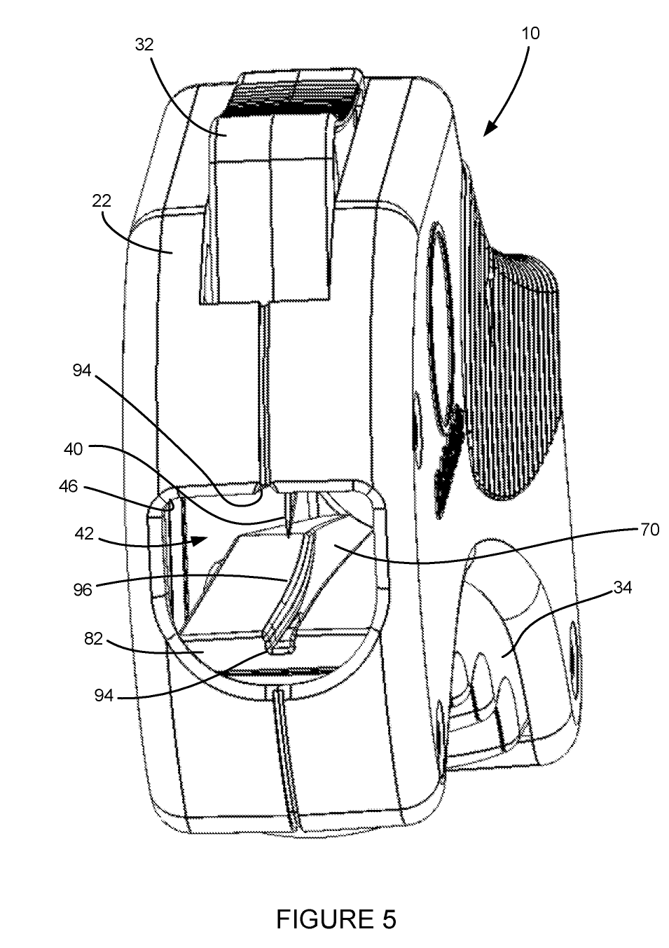

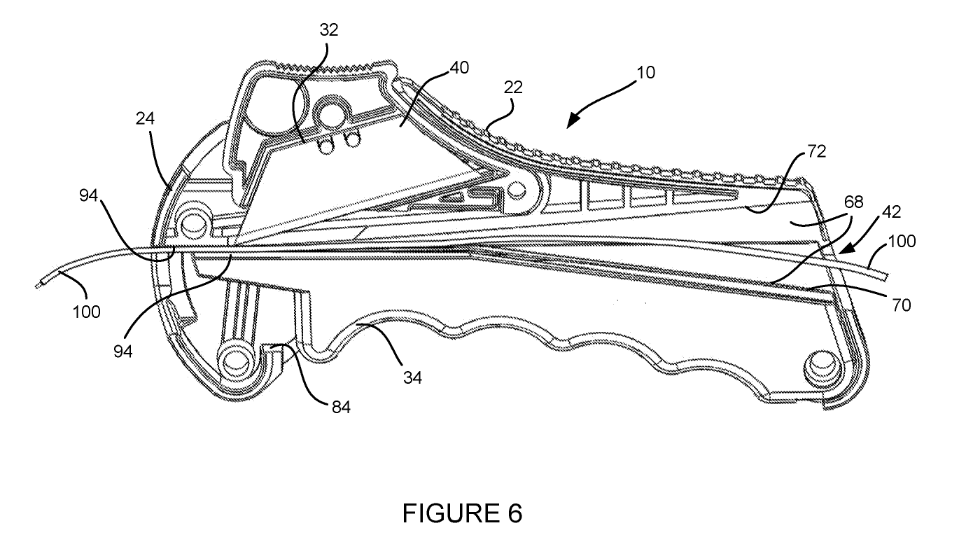

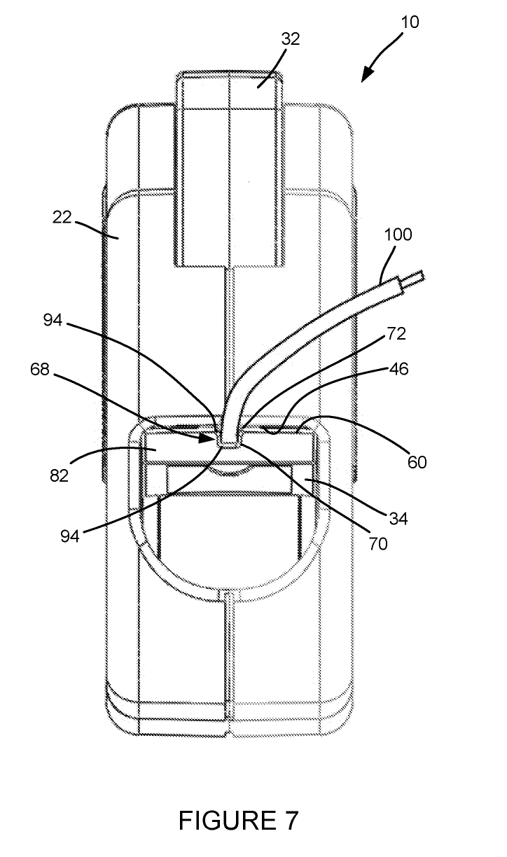

The distal end 94 of the cable guide, FIG. 5, can be formed to include a relatively small channel shape which can have beveled edges. During use, relatively small cables, (such as cable 100 in FIGS. 6 and 7), can be guided by the conical shape of the guide 68 into the small channel which aligns the cable under the blade 40. The distal end 94 of the guide can have a width and depth which allows small cables to fit lengthwise in the channel while contacting the bottom and both sides of the channel. This shape can maintain the small cable in alignment with the blade during use and can help to prevent the cable from moving laterally relative to the blade or from rolling around the cable's center axis while the cable insulation is cut. By having the cable contact the recess at the bottom and two sides, the recess can hold smaller cables more securely than a recess that contacts the cable in only two places. The distal end 94 of the guide can include channel elements in the upper guide portion 72 as well as the lower guide portion 70.

A side view of the cable stripper 10 is shown in FIG. 6 with the second side 26 (FIG. 1) of the body removed to illustrate the operation of the stripper. The first side 24 of the body is shown along with the blade holder 32, the gripper mechanism 34, and the blade 40. Cable 100 is a relatively smaller cable and can have a cross sectional diameter of approximately 1 mm. Cable 100 extends through the passage 42 and is centered under the blade using the conical shaped cable guide 68 defined by the upper guide portion 72 and the lower guide portion 70. As shown, cable 100 is substantially retained on three sides at a position centered under the blade by the relatively narrow recess or channel at the distal end 94 of the cable guide. The gripper mechanism is shown extended toward the blade to a position in which the gripper mechanism presses the cable against the upper guide portion 72 to restrain the cable against movement other than along the cable's longitudinal axis. The gripper mechanism can be used to press or squeeze the cable in the cable guide has hard or as soft as wanted by the user. The blade is shown in a retracted position in FIG. 6. In this position, the blade tip is not within the passage.

Cable 100 is shown in FIG. 7 extending from the distal end 46 of the passage through the cable stripper 10. The gripper mechanism 34 is in the extended position and the cable has been captured in the cable guide and guided to position under the blade. From this position, the blade holder 32 can be pressed to force the blade into the cable insulation, and the cable can be pulled through the cable stripper to cut the insulation lengthwise so that the insulation can be removed from the cable conductor. As shown in FIG. 7, the cable is restrained in the distal end 94 of the cable guide. Since the cable guide includes the channel like shape at the distal end, and the cable guide is includes upper and lower guide portions, the cable can fit substantially entirely within the cable guide, in cross section, for accurately and securely guiding the cable under the blade.

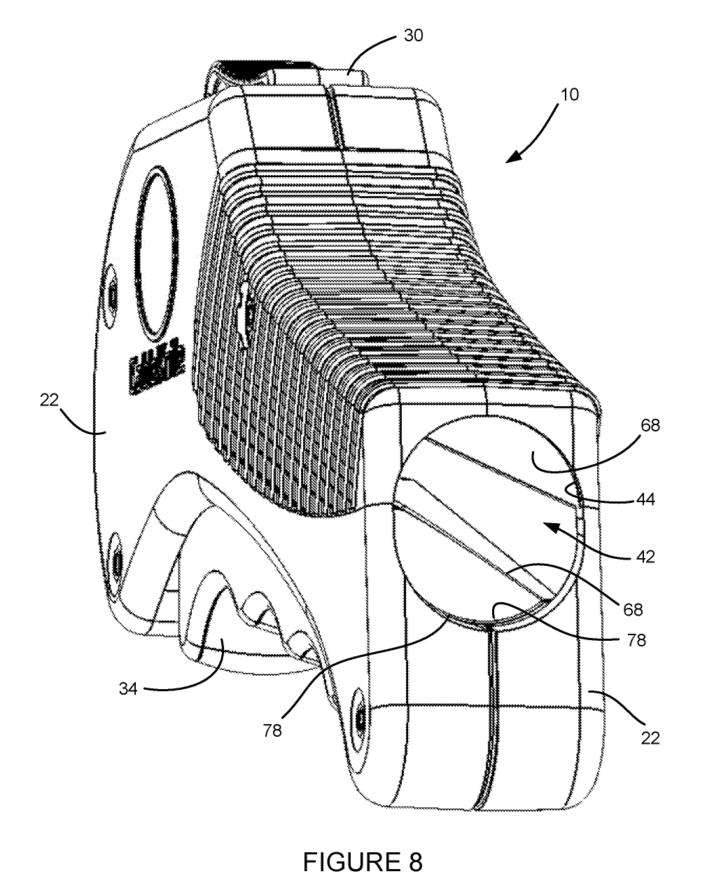

The proximal end 92 of the cable guide 68, FIG. 8, can be formed to have a partial circular cross section which can match a portion of the proximal end 44 of passage 42. The proximal end 78 of the gripper mechanism is relatively close to the pivot 76 (FIG. 3), therefore the proximal end 92 of the cable guide does not move as much as the distal end 94 of the cable guide during operation. Since the conical shaped cable guide 68 tapers from the relatively wider recess at the proximal end 92 to a relatively narrower recess at the distal end 94, the guide tends to move cables that are inserted through the proximal end of the passage toward the center, side to side, which is under the blade. The shape of the proximal end of the cable guide can match a portion of the shape of the proximal passage end 44 so that the cable guide 68 can receive the cable without interfering with the insertion of cable into the passage 42.

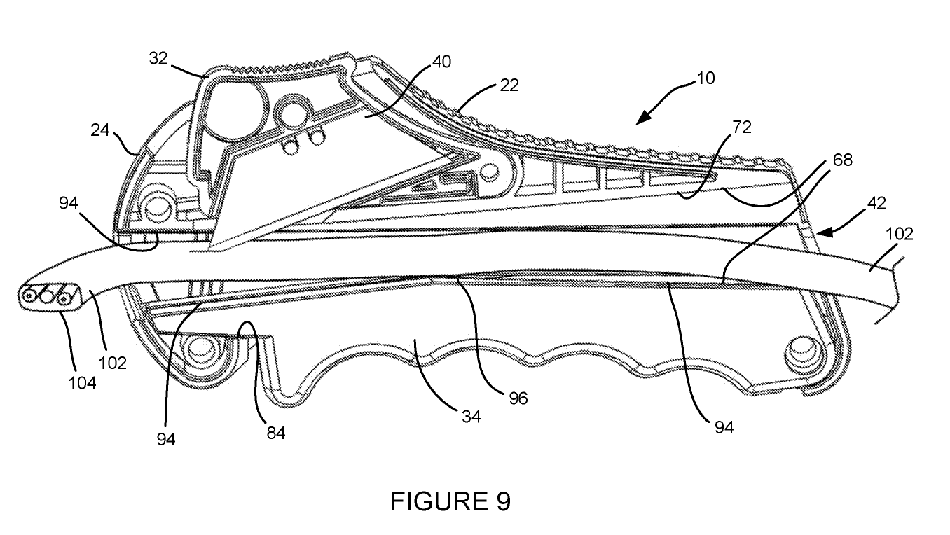

A side view of the cable stripper 10 is shown in FIG. 9 with the second side 26 (FIG. 1) of the body removed to illustrate the operation of the stripper. The first side of the body is shown along with the blade holder 32, the gripper mechanism 34, and the blade 40. In this Figure, a cable 102 is shown which includes a non-circular cross section which can be referred to as flat cable. Cable 102 includes a cross sectional dimension of 19 mm in a first direction, and a cross sectional dimension of 10 mm in a second, perpendicular dimension. This type of cable can have relatively larger conductors sized for carrying relatively larger current, such as for powering a home. The cable 102 can have an outer sheath 104 that contains two or more inner cables. As can be seen by the diagram, the cable 102 easily fits within the passage so the cable stripper can be used to cut the outer sheath. Unlike the smaller cable 100 (FIG. 6), the larger cable 102 does not fit within the relatively narrow recess at the distal end 94 of the cable guide. Instead, cable 102 is guided to be centered under the blade 40 by the relatively wider recess at the distal end 94 and intermediate profile 96 of the cable guide. The conical shape of the cable guide can guide cables to center under the blade by having a taper that has dimensions to correspond to the outer dimensions of the cables, such as is shown with cable 102 and where the intermediate profile 96 is indicated in FIG. 9. A cable having a cross sectional dimension between cable 100 (FIG. 6) and cable 102 (FIG. 9) can be guided to center under the blade by an area of the cable guide 68 somewhere between the areas of the guide used by cables 100 and 102. In an embodiment, cable stripper 10 can be used to strip cables having a cross section diameters from 1 mm to 15 mm and flat cable up to and including 19 mm×10 mm. This range covers all typical domestic use cables.

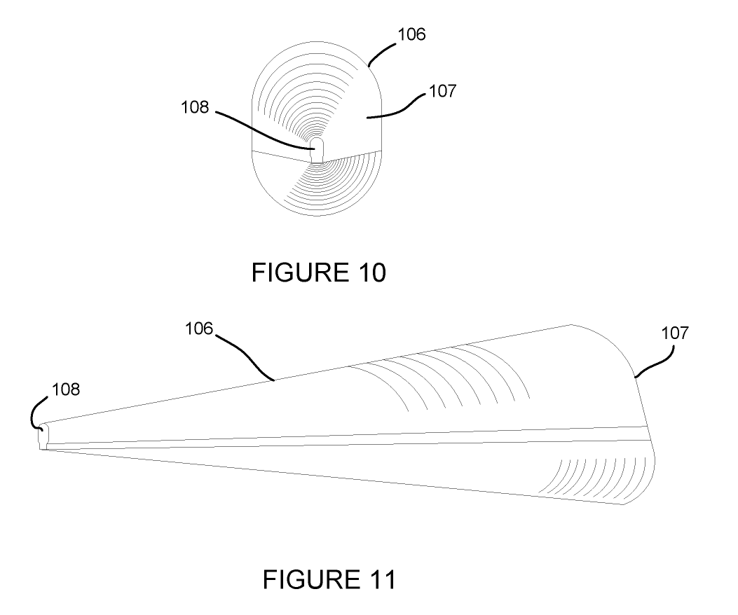

The cable guide can include squared off sides in the intermediate profile which can be used for centering flat cables. A conical shape having squared off sides in the intermediate profile is shown in FIGS. 10 and 11. FIG. 10 shows an end view of a conically shape passage 106 and FIG. 11 shows a side view of the conically shaped passage. The passage can be used in the cable stripper for guiding cables into and through the stripper such that the cable is positioned so that the blade 40 can cut the insulation of the cable. The passage can include a proximal opening 107 and a distal opening 108.

Although the cable stripper has been discussed up to this point in a configuration in which the gripper is actuated by the user's fingers and the blade holder is actuated by the user's thumb, in another embodiment, the cable stripper can be configured so that the gripper is actuated by the user's palm and the blade holder is actuated by the user's index finger. In this configuration, the body can include finger recesses for the user's fingers and the gripper can be arranged to contact the user's palm so that the palm rotates the gripper about the axis to grip the cable in the passage. Also, in this configuration, the user's index finger and apply pressure as needed to press the blade into the cable insulation. The conical shape may be formed with the relatively smaller recess either as part of the gripper mechanism or the body.

The cable stripper includes separate hinged movement for the lower guide portion 70, as part of the gripper mechanism 34, and for the blade 40. Having separate hinged movement allows the user to apply as little or as much force as is needed to the gripper and blade independently from one another. This means that he cable stripper can be held and operated with a single hand. The gripper allows the user to control how hard the cable is pressed in the guide so that the user can feel how much force is needed to maintain the cable in the guide, centered under the blade while not applying so much force that it is overly difficult to pull the cable through the cable stripper. The gripper can also be used to hold the cable, without using the blade, while the user move their hand from pushing the cable into the proximal end of the passage to the distal end of the passage where the other hand (non-tool hand) can be used to pull the cable through the passage. The independent movement of the blade allows the user to feel how the blade is cutting the insulation so that only the minimum pressure necessary to cut the insulation is used and the blade is not pressed against the conductor with unnecessary force. By having the guide and the blade move independently from one another, the guide can force the cable against the opposite side of the passage while the blade is extended or retracted. The blade can be extended while the gripper is retracted against the stop. Also, the user can force the guide and blade toward one another such that the blade cuts the insulation without the guide forcing the cable against the upper passage surface, which can allow the user to have another type of feel for how the blade is cutting. The independent movement of the blade and guide allow the user to strip a variety of different cable configurations and sizes without prior set-up for each cable type as well.

Both the gripper and blade holder have bias springs. The blade holder spring is arranged to hold the blade out of the passage. The gripper bias spring is arranged to hold the gripper such that the passage is open to have the largest cross sectional area. The bias springs can have a relatively light resistance so that the user's feel for the guide and blade has less influence from the springs. Because the bias springs retract the blade and open the passage, the cable stripper is ready to have a cable inserted by sampling relaxing the user's grip and thumb pressure on the stripper.

Having the blade arranged to extend into a passage, and having the blade biased out of the passage allows the user to keep the cable stripper in a pocket or tool belt without substantial risk of cutting. In order for the blade to inadvertently cut the user, the user would have to insert an individual finger into the passage while the blade is extended, and the user is likely to feel a single finger entering the passage before the finger could reach the blade. Since the cable stripper can be safely kept in a pocket or tool belt, a user can have the cable stripper handy during installation of cables which can make it more likely that the scrap cables are stripped.

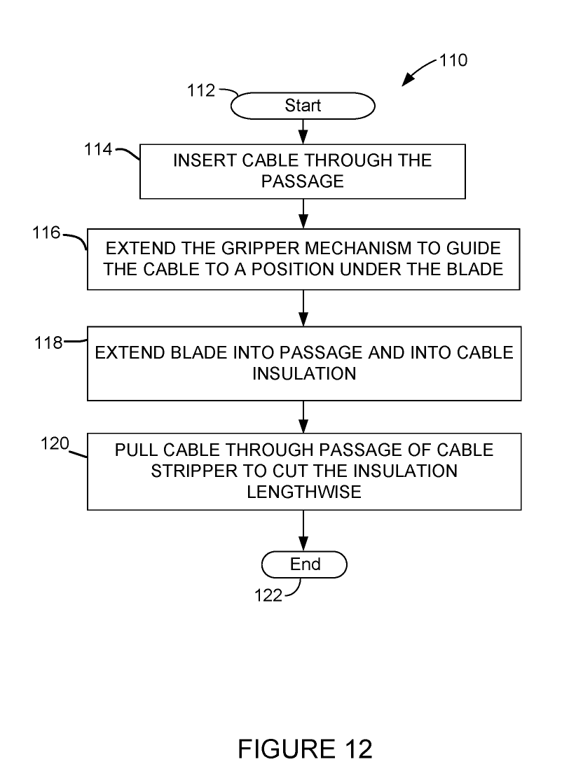

A method 110 is shown in FIG. 12 for stripping insulation from cables using a cable stripper 10. Method 110 begins at 112 and proceeds to 114 where an end of a cable is inserted into the proximal end of the passage of the cable stripper, through the passage and out of the distal end of the passage until a short length of the cable extends from the stripper. The method then proceeds to 116 where the gripper mechanism is extended to guide the cable to a position under a blade. In some instances, especially smaller cables, the gripper mechanism can be extended without much force. The method then proceeds to 118 where a blade holder extends a knife blade into the cable, such as by pressing the blade holder with the user's thumb, which causes the blade to slice the insulation of the cable. In practice it takes very little time to figure out how much pressure is required to cut through the insulation. Scoring the insulation with the blade, rather than cutting completely through the insulation, can also be used to allow the user to remove the insulation from the conductor.

The method then proceeds to 120 where the cable is pulled through the cable stripper to cut the cable insulation along the length of the cable. The user can pull the cable through the cable stripper with one hand while applying even pressure on the gripper and the blade holder using the other hand. Method 110 then proceeds to 122 where the method ends. After the cable has been sliced the insulation can be removed from the conductor of the cable. Since the cable insulation is sliced or scored lengthwise, the insulation can be easily peeled away from the conductor. After the cable is pulled all of the way through the cable stripper, the user can ease off the pressure on the gripper and blade holder to allow them to return to the retracted positions. Then the user can insert another cable to repeat the stripping process.

The body, blade holder and gripper mechanism can be made from one or more plastic, metal and/or other materials. The sides of the body can be fastened together and the sides of the blade holder can be fastened together using screws, bolts or other fasteners or can be snapped together or held in another manner. The blade holder and gripper mechanism can be retained in the body by the first and second sides of the body.

The cable stripper does not require a screw or other adjustment to be set to a fixed position at a predetermined cutting depth prior to inserting a cable. The cable stripper is configured such that the user's hands are protected from accidental contact with the blade which allows the user to grab the cable stripper without having to look and make sure that they are not going to cut themselves. The cable stripper is relatively small and lightweight which allows the user to keep the cable stripper in a pocket or tool belt. The cable stripper uses common and inexpensive utility knife blades for convenience and economy. The cable stripper can be used to strip all of the cables that are commonly used in residential construction.

Various embodiments of cable stripper apparatus, and the use and construction of the apparatus, are disclosed herein which can be used for stripping insulation from cables. Applicants submit that the apparatus, systems and methods according to the present disclosure provide sweeping and heretofore unseen benefits that are not recognized by prior art.

While a number of exemplary aspects and embodiments have been discussed above, those of skill in the art will recognize certain modifications, permutations, additions and sub-combinations thereof.

What is claimed is:

1. A cable stripper for stripping cable insulation from cable conductors of an electrical cable, comprising:
a body defining a portion of a cable passage, the passage extending from a first end of the body to a second end of the body, the body configured for receiving the electrical cable in the passage;
a blade holder connected to the body and configured for holding a blade such that the blade is extendable into the passage to cut conductor insulation by applying a force to the blade holder and the blade is retracted from the passage when the force is not applied to the blade holder;
a gripper mechanism connected to the body, the gripper mechanism defining a portion of the cable passage and wherein the gripper mechanism is configured such that applying a force to the gripper mechanism extends the gripper mechanism and narrows a portion of the passage to position the electrical conductor relatively closer to the blade, and wherein passing the electrical cable through the passage while extending the blade and applying the force to the gripper mechanism cuts the cable insulation and allows the cable insulation to be peeled away from the cable conductor.

2. The cable stripper as defined in claim 1, wherein the gripper mechanism includes a guide shape for guiding the electrical cable toward the blade.

3. The cable stripper as defined in claim 2, wherein the blade is extendable relatively closer to the second end of the body and relatively further from the first end of the body and the guide shape is relatively wider toward the first end of the body and relatively narrower toward the second end of the body, and the relatively narrow portion of the guide shape is aligned with the position of the blade when the blade is extended.

4. The cable stripper as defined in claim 2, wherein the blade is extendable into the passage near the second end of the body and the gripper mechanism is configured to extend by pivoting at a pivot near the first end of the body.

5. The cable stripper as defined in claim 1, wherein the passage includes a conically shaped guide when the gripper mechanism is extended.

6. The cable stripper as defined in claim 1, wherein the blade holder includes a portion for contacting and receiving force from a user's thumb to extend the blade into the passage.

7. The cable stripper as defined in claim 1, wherein the gripper mechanism includes grip recesses for receiving force from a user's fingers to extend the gripper mechanism and position the electrical conductor relatively closer to the blade.

8. The cable stripper as defined in claim 1, wherein the blade holder and the gripper mechanism are extendable independently from one another.

9. The cable stripper as defined in claim 1, wherein the passage is open at the first and second ends of the body and is enclosed in between the first and second ends of the body.

10. The cable stripper as defined in claim 1, wherein the blade holder is configured to hold a standard utility knife blade.

11. A method for stripping insulation from a cable using a cable stripper, comprising;
inserting an end of the cable into a proximal end of a passage of the cable stripper;
pushing the cable through the passage until the cable end extends from a distal end of the passage;
applying a force to a gripper mechanism to extend the gripper mechanism and thereby position the cable under a blade;
applying a force to a blade holder to extend a blade into the passage and into the insulation of the cable;
pulling the cable through the passage to cut the cable insulation along the length of the cable.

12. The method for stripping insulation as defined in claim 11, further comprising removing the cut insulation from the cable conductor.

13. The method for stripping insulation as defined in claim 11, wherein applying the force to the gripper mechanism and applying the force to the blade holder are simultaneous.

14. A cable stripper for cutting insulation of an electrical cable, comprising:
a body defining at least a portion of a passage, the passage extending from one end of the body to another end of the body and configured for passing electrical cables longitudinally through the passage;
a blade holder for selectively extending a blade into the passage and retracting the blade from the passage;
a gripper mechanism for selectively moving electrical cables in the passage relatively toward and away from the blade;
a cable guide configured for guiding electrical cables laterally toward the blade while the electrical cables are moving longitudinally through the passage, the cable guide including a tapered shape that includes a relatively wider recess away from the blade and a relatively narrower recess closer to the blade.

15. The cable stripper as defined in claim 14, wherein the gripper mechanism includes at least a portion of the cable guide.

16. The cable stripper as defined in claim 15, wherein the body includes a portion of the cable guide.

17. The cable stripper as defined in claim 14, wherein the blade holder is configured to hold a standard utility knife blade.

18. The cable stripper as defined in claim 14, wherein the gripper mechanism is selectively movable in an arcuate motion about a pivot.

19. The cable stripper as defined in claim 14, wherein the blade holder selectively extends the blade in an arcuate motion about a pivot.

20. The cable stripper as defined in claim 14, wherein the gripper mechanism and the blade holder are movable independently from one another.
